(19) United States
(12) Patent Application Publication
(10) Pub. No.: US 2025/0144945 A1
(43) Pub. Date: May 8, 2025

(54) APPARATUS AND METHOD FOR PRINTING ON A CONTAINER

(71) Applicant: Ranpak Corp., Concord Township, OH (US)

(72) Inventors: Johannes E.G. WELTEN, Valkenburg a/d Geul (NL); Roel DRIESSENS, Bunde (NL)

(73) Assignee: Ranpak Corp., Concord Township, OH (US)

(21) Appl. No.: 18/834,855

(22) PCT Filed: Jan. 23, 2023
(86) PCT No.: PCT/US2023/061107

§ 371 Date: Jul. 31, 2024

Related U.S. Application Data
(60) Provisional application No. 63/267,313, filed on Jan. 31, 2022.

(51) Int. Cl. B41J 3/407; B41J 25/304; B65B 59/00; B65B 61/26

(52) U.S. Cl. CPC B41J 3/4073; B41J 25/304; B65B 59/003; B65B 61/26

(57) ABSTRACT

A printing system that allows printing directly on surfaces of random-height packages includes features to adjust the height of a printer to accommodate differences in heights of different packages. A macro adjustment of printer height may made of the printer relative to a frame. A conveyer, for example a high-friction belt, moves the package into a printing region between the printer and the belt, where the printer prints information on the package, such as address information and/or other information that might normally be printed on a label. The printer height may be adjusted by a lifter that raises the printer relative to the frame to an individual height suitable for printing on that package. As the package passes through the printing region the printer may be maintained at that individual adjusted height suitable for that particular package.

### FIELD OF THE INVENTION

The present invention relates generally to the field of handling packages, and providing information on a package.

### BACKGROUND

Oftentimes there is a need for providing information on a container or package, such as a box, used for shipping or transporting the article from one location to another. For example the container may have associated with it address information or other information about the destination or the contents, information that may be visible and consulted during shipment or transportation.

Information is often applied to containers or packages by use of adhesive labels, upon which the information may be printed. The label may then be affixed to the container or package. Automating the application of labels is complicated in random packaging situations, with different sizes of containers to be labeled.

### SUMMARY

While affixing a printed label is effective, it requires additional steps (separately printing and affixing) and additional materials (the label material and adhesive). The present disclosure describes a printing system for printing information directly on a container, such as a box with a lid or inwardly-folded flaps sized to close an open side of the box, with a height of a printer automatically adjusted to accommodate different heights of different containers.

An exemplary printing apparatus that facilitates printing directly on surfaces of packages, such as boxes, having different heights (height dimensions) includes features to adjust the height of a printer to accommodate differences in heights of different packages. A conveyer, for example a high-friction belt, moves the package or other item to be printed on into a printing area between the printer and the belt, where the printer prints information on the package, such as address information, content information, and/or other information that might normally be printed on a label. A macro adjustment of printer height may be made of the printer relative to a frame that contains the printer. Afterward, the printer height may be adjusted by a lifter, such as a roller, that raises the printer relative to the frame to an individual height suitable for printing on that package. As the package passes through the printing area the printer may be maintained at that individual adjusted height suitable for that particular package, until the package has left the printing area between the printer and the conveyer.

An exemplary printing system includes: a frame, a printer that is height adjustable relative to the frame, and a lifter that lifts the printer as an item to be printed engages the lifter.

The lifter may include a roller or a sliding guiding element.

The lifter may be at a front end of the printer, where the item to be printed enters a printing region where printing of the item occurs.

The lifter may engage the item to be lifted at an angle of 2 degrees or less.

The printing system may additionally include a damper operatively coupled to the printer and the lifter, to damp movement of the printer relative to the frame as the printer is lifted by the lifter.

The printing system may additionally include a conveyer that conveys the box into a printing region between the printer and the conveyer.

The conveyer may include a belt.

The belt may be a high-friction belt.

The printing system may additionally include a support that maintains the printer lifted away from the conveyer while the item to be printed is in the printing region.

The support may include a pair of bars that engage the item to be printed.

The bars may be substantially parallel to a direction of travel of the item to be printed, through the printing region.

The bars may engage the item to be printed outside of a print area on the item to be printed.

The bars may have upturned ends to facilitate engagement of the item to be printed as the item to be printed enters the printing region.

The support may include a roller that engages a top surface of the item to be printed, while the item to be printed is within the printing region.

The printing system may additionally include a low-friction coupling between the printer and the frame.

The low-friction coupling may include bearings.

The coupling may include roller bearings.

The printing system may additionally include springs that engage the printer and the frame, to bias the printer to a default height relative to the frame.

The springs may include coil springs.

The coil springs may include four coil springs, located at corners of the printer.

The printing system may additionally include a macro height adjuster used to selectively adjust height of the printer and the frame.

The macro height adjuster may include servo motors that adjust height of the printer and the frame.

The printing system may additionally include a lock that locks the printer and the frame together during operation of the macro height adjuster.

The lock may include a solenoid lock.

The lock may include a magnetic switch.

The item to be printed may be a box.

The printer may include a print head that prints on a print area of the item to be printed.

A method of printing an item to be printed includes the following steps: moving an object to be printed into a printing region between a printer and a conveyer that moves the object to be printed; during the moving, lifting the printer an amount corresponding to a height of the object to be printed, by the object engaging a lifter that is operatively coupled to the printer, to lift the printer; and printing the object to be printed by the printer, while the printer is lifted.

The method may additionally include the step of, prior to the moving of the object, setting an initial height of the printer such that the object will engage the lifter.

The method may additionally include the step of, while the object is in the printing region, maintaining the printer lifted, by engagement of the object with a support that is operatively coupled to the printer.

The printing step may include printing in a print area on the object.

The maintaining step may include engaging the object with the support outside of the print area.

### BRIEF DESCRIPTION OF THE DRAWINGS

FIG. 1 is a side schematic view of an exemplary printing system for printing directly on an item to be printed.

FIG. 2 is a top view of portions of an exemplary printing system.

FIG. 3 is a side view of a printer for use in an exemplary printing system.

FIG. 4 is a high-level flow chart of a method for printing directly on an item to be printed.

### DETAILED DESCRIPTION

An exemplary printing system prints information on a top surface of items to be printed, such as a packaging container, where the height of each container may be different. Thus, the printer needs to adjust in height, typically to a +/−1 mm tolerance. Too much distance between the printer and the item to be printed yields low printing quality. Too little distance (collision) may damage the printer.

Accordingly, the printer is pre-adjusted, such as via a servo mechanism, to an initial position near a planned or final height. The initial position is intentionally set slightly below the planned height (by approximately two or three millimeters, for example). The planned height can be measured or otherwise pre-determined, such as by a bar code, and communicated to the printing system. The item moves, such as by a conveyor, and comes into contact with the printing system, whereupon a guidance system will force the printer to move upward to the planned height, sliding or rolling the printer over the item. In other words, the item is moving in a horizontal direction past a static printer that moves vertically but is fixed in the horizontal direction. The guidance system may include a roller or a slide.

This double adjustment process helps to guarantee print quality and prevent damage to the printer, even with items that have a slightly different height than measured or items that are not perfectly flat.

To prevent high forces in the guidance system (damaging items to be printed or causing shocks to the printer), the printer may be carried by springs/dampers to take up a large part (80-90%) of the printer weight and absorb impacts upon engagement with the item to be printed. The first height adjustment to the initial height can be relatively quick, within approximately one second for a maximum of 400 mm of height adjustment.

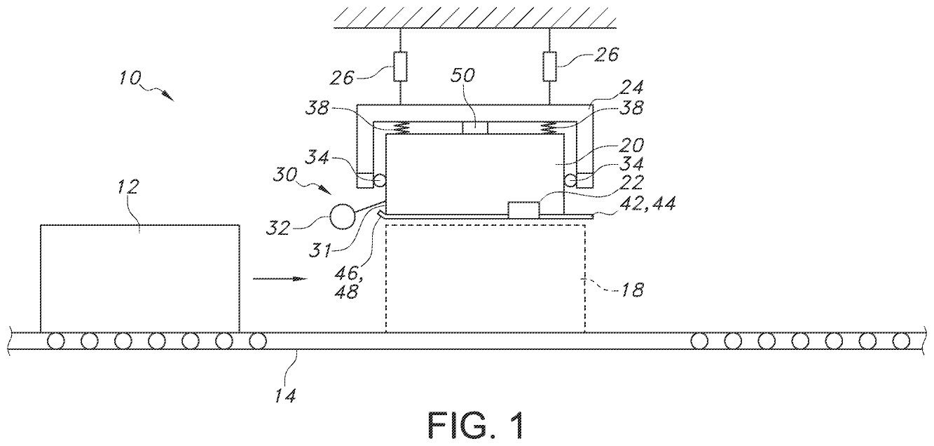

Turning now to the drawings, and initially to FIG. 1, FIG. 1 shows a printing apparatus or system 10 that is used for printing directly on the surface of a package or container (item to be printed), such as a box 12, having a random height dimension. The box 12 is moved along a conveyer, such as a conveyer belt 14 through a printing region 18 that is between a printer 20 and the conveyer belt 14. The belt 14 may be made of a high-friction material for preventing slippage between the box 12 and the belt 14. For example, the belt 14 may be made of rubber.

The printer 20 has a print head 22 that is configured to print directly on an upper surface of the box 12, such as a top lid or closed flaps of a box, as the box 12 passes through the printing region 18. The printer 20 may be any of a variety of suitable printers. Non-limiting examples include ink-jet printers and laser printers.

The printer 20 has an adjustable height that is able to compensate for differences in heights of different individual boxes or other containers or objects. The printer 20 is able to adjust its height relative to the conveyor belt 14 and/or a frame 24. The printer 20 thus is suitable for use in random packaging situations, where a height dimension of each box varies.

The height adjustment may include a macro height adjustment mechanism (or macro height adjustment) 26 that adjusts the initial height of the printer 20. The initial height of the printer 20 may be set to a level above the conveyer belt 14 such that boxes passing through the printing region 18 will require some individualized further height adjustment, raising the printer 20 by an amount necessary for proper printing of each individual box. The initial position is intentionally set slightly below the planned or final height (by approximately two or three millimeters, for example). The amount of raising or other height adjustment needed for this adjustment to the final height is relatively small, however, such that the printer 20 can be raised quickly from the initial height to the final height. This second height adjustment can be referred to as a micro height adjustment, in contrast to the initial height adjustment, which can be referred to as a macro height adjustment.

To accomplish a precise micro height adjustment the system 10 has a lifter 30 at a front end 31 of the printer 20 and optionally also at a back end of the printer 20. The lifter 30 engages the box 12 as the box 12 enters the printing region 18. The engagement between the lifter 30 and the box 12 causes the printer 20 to be raised by an amount appropriate for proper printing on the box 12. Printing requires a distance of less than about 1.5 mm between a print head and the printing surface to achieve proper quality. Flatness and height tolerance on boxes are often greater than about 2 mm (typically about 5 mm), and the micro adjustment ensures the proper height is maintained for quality printing even when the printing surface is not flat. The lifter 30 may for example be (or may include) a roller 32 that is mechanically coupled to the printer 22, bearings, or bars or other members that slide across the surface of the box 12. As the box 12 approaches the printing region 18 the box 12 makes contact with the roller 32, pushing the roller 32 upward. This contact also pushes the printer 20 upward within the frame 24, with the roller 32 attached to or otherwise mechanically coupled to the printer 20.

The roller 32 may engage the box 12 at a shallow angle. For example, the roller 32 may engage the box at angle of nine degrees or less, such as two degrees, although it will be appreciated that this is just an exemplary value, and that other values are possible.

The printer 20 may be moveable relative to the frame 24 through a low-friction coupling, such as with the illustrated roller bearings 34 between the printer 20 and the frame 24. The roller bearings 34 allow the printer 20 change height upward and downward without binding, and without any appreciable hysteresis.

There may be springs 38 coupled to the printer 20 and the frame 24, such as at corners of the printer 20, to provide a biasing force to return the printer 20 to a default height when there is no force retaining it in a raised condition. The springs 38 may be coil springs, and there may be four such springs. The springs 38 may be between the printer 20 and the frame 24, such as at corners of the printer 20. There may be more or fewer springs, and/or a different configuration of springs.

It may be desirable to maintain the printer 20 in its raised condition until the box 12 passes out of the printing region 18. This may avoid, for example, streaking or smearing of just-printed parts of the box 12 due to contact with parts of the printer 20 or other parts of the system 10. To accomplishing maintaining the printer 20 in the raised condition the system 10 may have a pair of support bars 42 and 44. The support bars 42 and 44 may include inclined portions at an upstream end that function as the lifter 30.

In the illustrated embodiment, the support bars 42 and 44 are arranged on opposite sides of the printing region 18, along a bottom of the printer 18, in a direction substantially parallel to a direction of travel of the box 12 through the printing region 18. The support bars 42 and 44 may protrude down from the rest of the printer 20, and may make contact with the box 12 on opposite sides of the box 12, preferably outside of a print area on the box 12 where the printer 20 prints the information, so as to avoid smearing or streaking of the printing made on the box 12 by the printer 20. The support bars 42 and 44 may be configured to keep the printer 20 raised while any substantial part of the box 12 is still in the printing region 18, even after the roller 32 is no longer in contact with the box 12. The support bars 42 and 44 may have upturned ends 46 and 48 that facilitate movement of the support bars over a top surface of the box 12. The support bars 42 and 44 also maintain a predetermined spacing between the printer 20 and the printing surface in the printing region 18.

Any of a variety of suitable information may be printed on the object, such as the box 12. For example, information about routing or the recipient may be printed, such as the recipient's name and address. Other sorts of information may also (or alternatively) be printed on the object, such as handling instructions, or indications of the contents, source, brand, photograph, or history of the object. Printing directly on the object also facilitates individualization of packaging and higher flexibility in branding compared to the prior practice of inserting pre-printed materials into a package.

Optionally, a damper 50 may be located between the printer 20 and the frame 24 and the printer 20. The damper 50 may be, for example, one or more pads of a flexible/resilient material, such as rubber. The damper 50 employed to control vibrations and/or fast movements of the printer 20 relative to the frame 24. The damper can reduce vertical movement and vibration as a result of inertia after the macro height adjustment.

Also optionally, the system 10 may have an actuatable lock 54 between the printer 20 and the frame 24. The lock 54 may be activated to secure the printer 20 and the frame 24 together during operation of the macro height adjuster 26. Locking the printer 20 to the frame 24 just before starting the macro height adjustment and releasing the printer 20 to move relative to the frame 24 after the macro height adjustment can minimize vibration while allowing for the micro height adjustment to follow. Non-limiting examples of suitable locks include solenoids and magnetic switches.

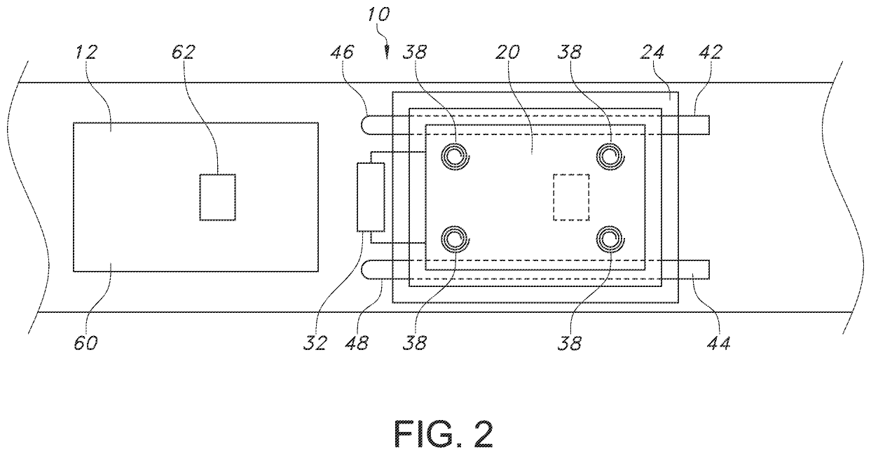

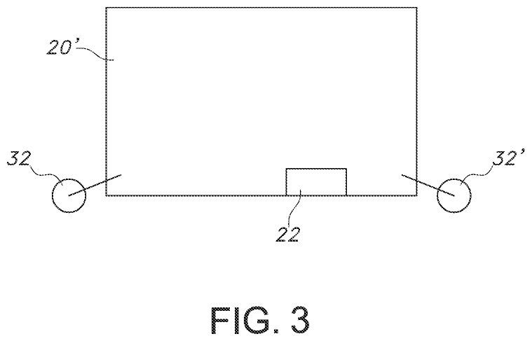

FIG. 2 illustrates the process from another view. The box 12 has a top surface 60, with a print area 62 on the top surface 60 that will eventually be printed by the print head 22. The support bars 42 and 44 are configured to engage the box top surface 60 on opposite sides of the print area 62, and outside of the print area 62. This avoids any streaking or smearing of freshly printed material. FIG. 3 shows an alternative embodiment of an exemplary printer 20′ that, in addition to a roller 32 at its front end 31, includes one or more rollers 32′ at a back end 33. The one or more rollers 32′ may function as the support that keeps the printer 20′ raised while the container (such as a box) is in the printing region.

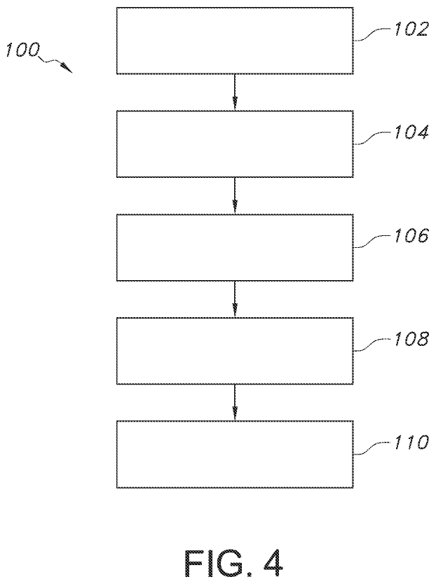

FIG. 4 shows a high-level flow chart of a method 100 for printing directly on an object to be printed, for example using the printing system 10 (FIG. 1) described above. In step 102 an initial height of the printer 20 (FIG. 1) is set, using the macro height adjuster 26 (FIG. 1). As described earlier, this initial height is set such that the lifter 30 (FIG. 1) engages the items to be printed, allowing an individualized adjustment of the height of the printer 20 for each object.

In step 104 an individual object (such as the box 12 (FIG. 1)) enters the printing region 18 (FIG. 1), conveyed by the conveyer belt 14 (FIG. 1). As this occurs, in step 106 the object engages the lifter 30 (FIG. 1), which in turn causes a lifting of the printer 20 by an amount suitable for printing on the object 12.

In step 108 the object (such as the box 12 (FIG. 12)) is printed on by the print head 22 (FIG. 1). Finally, in step 110, the height of the printer 20 (FIG. 1) may be maintained in the lifted (raised) position until the object (the box 12) leaves the printing region 18 (FIG. 1).

In summary, a printing system 10 that allows printing directly on surfaces of random-height packages 12 includes features to adjust the height of a printer 20 to accommodate differences in heights of different packages 12. A macro adjustment of printer height may made of the printer 20 relative to a frame 24. A conveyer, for example a high-friction belt 14, moves the package 12 into a printing region between the printer 20 and the belt 14, where the printer 20 prints information on the package 12, such as address information and/or other information that might normally be printed on a label. The printer height may be adjusted by a lifter 30 that raises the printer relative to the frame 24 to an individual height suitable for printing on that package 12. As the package 12 passes through the printing region the printer 20 may be maintained at that individual adjusted height suitable for that particular package 12.

Although the invention defined by the following claims has been shown and described with respect to a certain embodiment, equivalent alternations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiments of the invention. In addition, while a particular feature of the invention may have been described above with respect to only one of several illustrated embodiments, such feature may be combined with one or more other features of the other embodiments, as may be desired and advantageous for any given or particular application.

1. A system for printing on a random-height container, the printing system comprising:
a frame;
a printer that is linearly height adjustable relative to the frame; and
a lifter that lifts the printer as the container to be printed engages the lifter; and
a damper operatively coupled to the printer and the lifter, to dampen movement of the printer relative to the frame as the printer is lifted by the lifter.

2. The printing system according to claim 1, wherein the lifter includes a roller.

3. The printing system according to any one of claim 1, wherein the lifter is at a front end of the printer, where the container enters a printing region where printing occurs.

4. The printing system according to claim 1, wherein the lifter engages the container at an angle of 2 degrees or less.

5. (canceled)

6. The printing system according to claim 1, further comprising a conveyer that conveys the container into a printing region between the printer and the conveyer.

7. (canceled)

8. (canceled)

9. The printing system according to claim 6, further comprising a support that maintains the printer lifted away from the conveyer while the container is in the printing region.

10. The printing system according to claim 9, wherein the support includes a pair of bars that engage the container.

11. (canceled)

12. The printing system according to claim 10, wherein the bars engage the container outside of a print area on the container.

13. (canceled)

14. The printing system according to claim 9, wherein the support includes a roller that engages a top surface of the container, while the container is within the printing region.

15. The printing system according to claim 1, further comprising a low-friction coupling between the printer and the frame.

16. (canceled)

17. (canceled)

18. The printing system according to claim 1, further comprising springs that engage the printer and the frame, to bias the printer to a default height relative to the frame.

19. The printing system according to claim 18, wherein the springs include coil springs.

20. The printing system according to claim 19, wherein the coil springs include four coil springs, located at corners of the printer.

21. The printing system according to claim 1, further comprising a macro height adjuster used to selectively adjust a height of the printer relative to the frame.

22. The printing system according to claim 21, wherein the macro height adjuster includes servo motors that adjust height of the printer relative to the frame.

23. The printing system according to claim 21, further comprising a lock that locks the printer and the frame together during operation of the macro height adjuster.

24. (canceled)

25. (canceled)

26. (canceled)

27. (canceled)

28. A method of printing an item to be printed, the method comprising:
moving an item to be printed into a printing region between a printer and a conveyer that moves the item;
during the moving, lifting the printer an amount corresponding to a height of the item, by the item engaging a lifter that is operatively coupled to the printer, to lift the printer; and
printing on the item by the printer, while the printer is lifted.

29. The method according to claim 28, further comprising, prior to the moving of the item, setting an initial height of the printer such that the item will engage the lifter.

30. The method according to claim 28, further comprising, while the item is in the printing region, maintaining the printer lifted, by engagement of the item with a support that is operatively coupled to the printer.

31. The method of claim 30, wherein the printing includes printing in a print area on the object; and
wherein the maintaining includes engagement of the object with the support outside of the print area.
